(19) United States
(12) Patent Application Publication
(10) Pub. No.: US 2008/0309661 A1
(43) Pub. Date: Dec. 18, 2008

(54) METHOD FOR THE DISPLAY OF PROCESS INFORMATION FOR A DATA PROCESSING EQUIPMENT AS WELL AS DATA PROCESSING SYSTEM

(75) Inventor: Jens Urban, Dusseldorf (DE)

Correspondence Address: SHERIDAN ROSS P.C., 1560 BROADWAY, SUITE 1200, DENVER, CO, 80202, US

(73) Assignee: AVAYA GMBH & CO. KG, Frankfurt am Main (DE)

(21) Appl. No.: 11/852,013

(22) Filed: Sep. 7, 2007

(30) Foreign Application Priority Data
Jun. 18, 2007 (EP) EP 07 011 856.7

(51) Int. Cl. G06T 15/00

(52) U.S. Cl. 345/419

(57) ABSTRACT

A method for the display of process information for a data processing equipment shall enable a particularly simplified and flexible processing, even of complex datasets, based on situation or problem-specific evaluation rules. For this purpose, according to the invention, control data defining the rules for the evaluation of the diagnostic data are fed to an evaluation module, and the evaluation module effects, by means of the rules transmitted by the control data, an evaluation of the diagnostic data by means of which display data suitable for being output on a display device are generated.

The invention relates to a method for the display of process information for a data processing equipment. It also relates to a data processing system for carrying out the method.

During the creation and also during the operation of, in particular, complex data processing equipments or programs, usually a large number of measuring or monitoring data result which can change their values as a function of the current functional state or of the status of individual program modules or components, individual technical systems, subsystems or single modules or also as a function of the state or status of an underlying process. For example, such data or measured values may occur within the framework of systems of process control technique during the regular and continuous monitoring of the components and modules used in the monitored process, whereby individual measured values or data may take on, as a function of the monitored process state, values which are characteristic of that state. Alternatively or additionally, data or measured values of this kind may also result and be monitored, in particular in the form of recorded long-term information, during the internal monitoring of the operativeness or the status of single modules or components within a data processing equipment or to a particularly high extent also in the manner of a programming or creation aid for the creation of complex data processing systems and the combination of different modules for forming a higher-order functional sequence.

Especially in complex systems, usually considerable and large datasets result, which are subjected, in the manner of a statistical evaluation, to a systematic and usually function-related evaluation. For this purpose, the determined measured values or data are suitably linked with each other, in view of the evaluator's expert knowledge, so that, in the manner of a pattern recognition based on the large datasets and a suitable linking of individual data records with each other, specific diagnostic statements for the overall system can be made. The diagnostic statements can relate, for example, to the state of an equipment process monitored by the data processing equipment or else to the state and function of the data processing equipment as such or of individual or several of its components.

For such an evaluation of complex datasets, the latter are usually provided in a unified data format, in particular in the manner of a log or the like. In order to obtain reliable diagnostic statements by means of such datasets, a specific manipulation of, or intervention into, the dataset follows, usually effected by the evaluator, with which the data are edited in a suitable way and by means of rules from the evaluator's experimental knowledge. In this way, through a suitable grouping and selection of individual data records, specific diagnostic statements related in concrete terms to the respective problem or the respective monitored state can be made through a suitable grouping and selection of individual data records, beyond a purely statistical evaluation of such data, i.e. in particular beyond a mere analysis of frequency distributions. By means of the data manipulation individually carried out by the evaluator, the data can then be converted, in the manner of focused representations, into suitable output data which can be passed to a display unit, for example in the form of a graphical representation.

Instead of a manual pre-editing of the data, it is possible to implement in a data processing unit, in a function or problem-related manner, individual evaluation modules, so-called “tools”, which pre-edit the incoming complex data records of statistically distributed data by means of the pre-specified problem or module-specifically evaluation rules and then pass them to a suitable display unit. In such systems, the respective tool, containing the corresponding experimental knowledge for a suitable processing of the complex data records in the form of the evaluation rules stored in it, is first of all individually implemented on the respective data processing equipment to be used and then put at the user's disposal for being used. Such an embodiment can be important in particular when especially in complex systems, the intended user does not possess himself or personally the necessary rich experience to carry out the problem-specifically suitable evaluation and representation of the data. By incorporating the experimental knowledge in said tools, a suitable pre-editing of the complex statistical data can, therefore, be guaranteed independently of the person of the evaluator or subsequent processor.

On the other hand, the incorporation of the suitable evaluation rules in said tools or modules entails an additional and increased expenditure of evaluation of the data, in particular because the respective tools or modules have to be implemented, for each problem to be treated or the situation under consideration, in a specifically new manner on the evaluation equipment or operating device allocated to the user in question, in particular a personal computer.

Therefore, the invention is based on the problem to provide a method for the display of process information for a data processing equipment, enabling a particularly simplified and flexible processing even of complex datasets, taking situation or problem-specific evaluation rules as a basis. Furthermore, a data processing equipment particularly suitable for carrying out this method shall be provided.

Concerning the method, this problem is solved according to the invention by feeding diagnostic data characteristic of the process state or the function of the data processing equipment or of the process monitored by it, together with the rules for the evaluation of the control data defining the diagnostic data, to an evaluation module, and by evaluating in the evaluation module, in accordance with the rules transmitted by the control data, the diagnostic data by means of which display data suitable for being output on a display device are generated.

The invention is based on the idea that a reliable pre-evaluation of complex, in particular statistically relevant datasets should in any case take into consideration in a complete and comprehensive way the evaluation rules existing in the form of experimental knowledge for the situation or problem-specifically correct evaluation of the data. However, in order to avoid in this connection, for the sake of simplified handling, a relatively expensive individual problem or situation-specific separate implementation of individual tools or modules on the users' corresponding evaluation devices, the experimental knowledge necessary for the correct evaluation of the datasets should be made available independently of such separate modules. For this purpose, it is provided to supply the situation-specific desired or necessary evaluation rules directly and immediately together with the data to be evaluated, i.e. in particular the diagnostic data, so that based on a data record comprising, on the one hand, the diagnostic data and, on the other hand, the control data containing the evaluation rules, the further evaluation and in particular also the forwarding to suitable display systems can be carried out using standard components which are anyhow available on usual user systems.

Advantageously, the control data containing the evaluation rules are buffered together with the diagnostic data to be evaluated in a common log file, so that in the manner of a temporary or definite archiving, access to the respective data records obtained is also possible at a later date. Within the log file, the control data on the one hand and the diagnostic data on the other hand occupy separate sections, so that a relatively simple and specific access to either the control data or the diagnostic data is possible. In the manner of a first section, the control data can in particular form a so-called head of the log file, where the evaluation rules for the following diagnostic data are stored.

Advantageously, the log file is stored together with a time parameter characteristic of the time of its storing. In particular when storing a plurality of log files, which may also differ from each other, regarding the problem to be monitored or the like, through different evaluation rules suitably stored in the respective section, the user is thus enabled to individually evaluate different events subsequently in a time-resolved or, for example, date-related manner, so that, for example, also through a correlated diagnosis of separate events in the matter of a higher-order diagnosis or the like, he can draw conclusions regarding overall reasons for the process or the equipment to be monitored.

Depending on the process to be monitored and in particular in view of the continuous monitoring of industrial processes, for example in the form of a monitoring using process control technique or a continuous monitoring of data processing equipments, the diagnostic data are advantageously updated at regular intervals or cyclically with a specifiable cycle time. In another advantageous embodiment, the updated diagnostic data, the control data and a parameter characteristic of the respective recording time are stored separately, in the form of a common data record, in a recording time-specific log file. In this way, in the manner of a logging of the monitored equipment sequences, a subsequent dynamic analysis of the equipment processes is possible.

The simplified pre-evaluation of complex data records through the common provision of diagnostic data on the one hand and of control data characteristic for the evaluation of the diagnostic data and their rules on the other hand is also suitable to a particularly high degree as an aid for creating complex data processing programs, in which the user or programmer is continually dependent on a systematic verification of the system sequences and the consequences caused by modifications. A particularly well suited aid for such a system or component diagnosis accompanying the programmation is the monitoring of so-called runtime data, with which the reaction of individual modules to specifically specified requirements or else their availability can be verified individually and specifically in a relatively simple way. Therefore, in a particularly advantageous embodiment, the diagnostic data comprise such runtime data.

Concerning the data processing system, the above-mentioned problem is solved with an evaluation module which carries out, by means of the rules defined in the control data, an evaluation of the corresponding diagnostic data and generates, by means of the results obtained, display data suitable for being output to an allocated output device.

The advantages achieved with the invention consist in particular in the fact that through the common provision of diagnostic data characteristic of the process state or the function of the data processing equipment or the monitored technical process, on the one hand, and of control data characteristic of the rules for the evaluation of the diagnostic data, on the other hand, a reliable evaluation, specifically adapted to the respective underlying problem or situation, even of complex datasets, is possible with relatively simple means and in particular using standard components which are stored or can be stored by the user. To individualize the evaluation—relating to the respective problem or situation—, the corresponding experimental values can suitably be integrated into the control data, so that exactly through the common provision of control data and diagnostic data, it is guaranteed that the rules and criteria necessary for the evaluation of the diagnostic data can be allocated correctly and can be taken into consideration in an unadulterated manner. It is, therefore, no longer necessary to separately implement suitable tools for these evaluation rules at the user or even only to concretely allocate the tools relevant for the respective diagnostic record through the user, the more so as the common storage of control data and diagnostic data in a common log file guarantees the correct correlation for the order between control data and diagnostic data. Therefore, a user of the evaluation software does not need to implement or to register any Plug-Ins or other tools for the display of specific data, as the corresponding evaluation rules are already suitably included in the respective file. Furthermore, differences between the generator and the subsequent user of the data are excluded, as the corresponding file includes its own evaluation rules in their up-to-date version.

One embodiment of the invention is explained in detail by means of a drawing in which

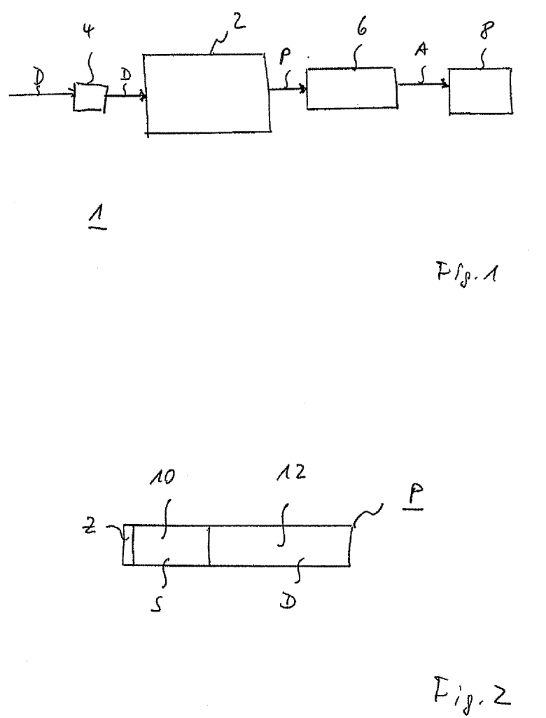

FIG. 1 shows a data processing system,

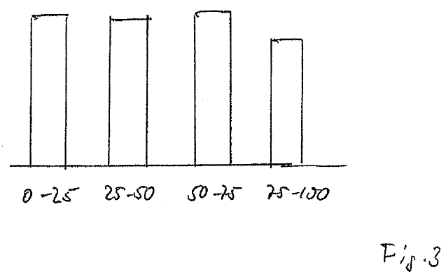

FIG. 2 shows a diagram for the creation of a log file, and

FIG. 3 shows a diagram with pre-evaluated diagnostic data.

Identical parts are marked with identical reference characters in all figures.

The data processing system 1 according to FIG. 1 is designed for an easier evaluation of complex measuring and diagnostic data, resulting, for example, from the monitoring of a technical process within the framework of a process control technique system or also within the framework of diagnosis and monitoring of individual software or program modules within an overall system. For this purpose, the data processing system 1 comprises a central module 2 on which the resulting measuring or process data can be stored in particular in the manner of the function of a main storage or central storage or also of a server. The input side of the central module 2 is connected with an input interface 4, through which diagnostic data D which are characteristic of the process state or function of the system or the equipment to be monitored and which can be available, for example, in the form of measured values, are passed to the central module 2. The kind and type of the input interface 4 and the diagnostic data D received by it and to be forwarded by it depend on the system or process to be monitored. If the process to be monitored is a technical one, in the manner of an embodiment according to process control technique, the incoming diagnostic data D can be available in the form of measured values for individual measured values characteristic of the process, or the like. If, on the other hand, the system to be monitored is a data processing equipment as such or else a data processing system or program to be created, the incoming diagnostic data D can be characteristic in particular of the function of individual modules or components of the equipment. In such a case, where the data processing equipment 1 is preferably used as an aid for creating software programs, the incoming measured values can in particular be runtime data or runtime values characterizing the reaction times of individual modules or components to incoming signals, requests or the like.

The user program or a server process which is connected upstream of the input interface 4 and which shall provide, as diagnostic data D, the statistical data for the evaluation, can in particular be connected before with a library storage or a library carrying out these tasks in its own module for the corresponding program,

In the exemplary embodiment, the quantity of data to be evaluated which is transmitted via the input interface 4 is so large that it is in principle not possible for the user to effect an evaluation of an individual case. Rather shall the incoming statistical data be edited in such a way that, in view of an evaluation rule specified in a specific and problem-related manner, a diagnostic evaluation, based on occurring patterns, is made easier for the user. For this purpose, the incoming diagnostic data D shall be evaluated according to rules fixed in a problem-related manner, in which substantially the experimental knowledge about the statistical treatment of large datasets is put into concrete terms, and shall graphically be displayed in a simplified form. In order to enable this in a particularly simple way, the evaluation rules to be taken into account for the respective evaluation case are stored on the central module 2 in the form of suitable control data by means of which the above-mentioned rules can be determined unambiguously and can be reconstructed. Type and mode of storage can be specified and put into concrete terms by the user or evaluator.

The diagnostic data D incoming through the input interface 4 are correlated and coupled in the central module 2 with the corresponding control data S, which are specifically related to the evaluation of the respective situation or problem. Then, a common log file P is created from the diagnostic data D on the one hand and the control data S corresponding to them and containing the relevant correct evaluation rules, on the other hand, said log file P being stored, ready for being called, in the central module 2.

The output side of the central module 2 is connected with an evaluation module 6, which, when needed, i.e. when an evaluation is desired, accesses the central module 2 and reads out the log file P which is stored there and is to be analyzed. Then, the evaluation module 6 analyzes the log file P, determining the share of the log file P which corresponds to the control data S and the share of the log file P which corresponds to the diagnostic data D. Based on this, the control data D determined in this way are converted in the evaluation module 6 into processing rules converting a processing of the diagnostic data D corresponding to the specified rules for die evaluation of the diagnostic data D. Based on the control instructions generated in this way in the evaluation module 6, the diagnostic data D are then preprocessed in accordance with the stored rules and converted into display data A which can be output on an allocated display unit 8. The display data A are adapted to the requirements of the display unit 8, in particular regarding their data structure and the like.

As can be seen from the diagrammatic representation in FIG. 2, the log file P constitutes a common data record for the diagnostic data D on the one hand and the control data S on the other hand. When the log file P is created, the control data S are combined in a first segment 10 and the diagnostic data D,in a second segment 12. Then, the data segments are aligned in the form of a common data string, the first segment 10 allocated to the control data S forming the front section or “head” of the log file P. Furthermore, the log file P is completed, in addition to the control data S and the diagnostic data D, by time parameters Z characteristic of the time of creation.

In particular when monitoring continuous processes, a cyclic updating of the obtained measured values can be provided. For this purpose, diagnostic data D newly incoming through the input interface 4 are updated cyclically, i.e. preferably at regular time intervals, and are stored together with the control data S—which usually remain unchanged for the same evaluation case—as an updated log file P.

The log file P is designed in such a way that the common provision of diagnostic data D on the one hand and control data S on the other hand, enables a simplified preprocessing of the diagnostic data D to be evaluated, using standard components which are anyhow available on a typical workstation of the user and do not have to be installed separately.

One example of the preprocessing of determined diagnostic data D, which shall enable an easier system diagnosis in a simplified graphic representation in the manner of a pattern, is shown in the diagram according to FIG. 3. The diagnostic data D taken as a basis here is any measured value or also any parameter characterizing, for example, the runtime or reaction time of a software module. Concerning this exemplary diagnostic parameter, the experimental knowledge could be that in case of proper function of the system, this parameter should occur with almost uniform distribution within a given parameter range. The experimental knowledge could in particular be that the ranges 0% to 25%, 25% to 50%, 50% to, 75% and 75% to 100% of the respective parameter range should show an almost uniform occupation. This experimental knowledge would lead to an evaluation rule saying that incoming diagnostic data D shall be categorized and represented in groups, whereby four columns corresponding to the ranges 0 to 25%, 25 to 50%, 50 to 75% and 75 to 100% should be displayed. On this basis, it will then be easier for the user to diagnose that the system is functioning properly when all four bars have almost the same value and that a system error is given when, for example, one of the bars differs greatly from the values of the other bars.

That means that in such a case, the easier system diagnosis could be achieved by representing the incoming diagnostic data D in a categorized and grouped manner in the corresponding four groups, so that the user can draw a corresponding diagnostic conclusion at first glance. This evaluation rule, i.e. the categorization and grouping of the incoming diagnostic data D in the above-mentioned four groups would suitably be converted, as the evaluation rule to be taken as a basis, into control data S, which are allocated to the corresponding diagnostic data D. As soon as afterwards, an evaluation unit 8 connected downstream reads out a log file P configured in this way, a routine will be started or implemented on the basis of the information contained in the control data S, which automatically distributes the diagnostic data D which are supplied at the same time, to the above-mentioned four groups and catagorizes them and graphically represents their distribution in a suitable way. One result of such a representation, namely the frequency distribution of the above-mentioned four bars, is shown diagrammatically in the diagram according to FIG. 3.

1. Method for the display of process information for [[a]] data processing equipment, comprising:
feeding diagnostic data characteristic of a process state or the function of the data processing equipment, together with control data defining the rules for the evaluation of the diagnostic data to an evaluation module, and
effecting, by the evaluation module and using the rules transmitted by the control data, an evaluation of the diagnostic data by means of which display data suitable for being output on a display device are generated.

2. Method according to claim 1, wherein the control data are temporarily stored, together with the diagnostic data, in a common log file.

3. Method according to claim 2, wherein the control data form a first section and the diagnostic data form a second section, separate from the first section within the log file.

4. Method according to claim 1, wherein the diagnostic data are cyclically updated with a specifiable cycle time.

5. Method according to claim 4, wherein each data record comprising the updated diagnostic data, the control data and a parameter characteristic of the recording time is stored separately in a recording time-specific log file.

6. Method according to claim 1, wherein the diagnostic data comprise runtime data.

7. Data processing system for carrying out the method according to claim 1, having an evaluation module which, by means of the rules defined in the control data, effects an evaluation of the corresponding diagnostic data and generates, by means of the results achieved, display data suitable for being output on an allocated display device.

8. Method according to claim 2, wherein the diagnostic data are cyclically updated with a specifiable cycle time.

9. Method according to claim 3, wherein the diagnostic data are cyclically updated with a specifiable cycle time.

10. Method according to claim 2, wherein the diagnostic data comprise runtime data.

11. Method according to claim 3, wherein the diagnostic data comprise runtime data.

12. Method according to claim 4, wherein the diagnostic data comprise runtime data.

13. Method according to claim 5, wherein the diagnostic data comprise runtime data.

14. Data processing system for carrying out the method according to claim 2, having an evaluation module which, by means of the rules defined in the control data, effects an evaluation of the corresponding diagnostic data and generates, by means of the results achieved, display data suitable for being output on an allocated display device.

15. Data processing system for carrying out the method according to claim 3, having an evaluation module which, by means of the rules defined in the control data, effects an evaluation of the corresponding diagnostic data and generates, by means of the results achieved, display data suitable for being output on an allocated display device.

16. A computer readable medium comprising processor executable instructions to perform the steps of claim 1.
